(19) United States
(12) Patent Application Publication
(10) Pub. No.: US 2015/0088551 A1
(43) Pub. Date: Mar. 26, 2015

(54) SYSTEM AND METHOD FOR GROUP BENEFIT INSURANCE PLAN PLATFORM

(71) Applicants: David Conn Morgan, Collinsville, CT (US); Bradley Dean Molinsky, Bloomfield, CT (US); Meghan Brooks Pistritto, Rocky Hill, CT (US); Thomas Andrew Tipton, Burlington, CT (US)

(72) Inventors: David Conn Morgan, Collinsville, CT (US); Bradley Dean Molinsky, Bloomfield, CT (US); Meghan Brooks Pistritto, Rocky Hill, CT (US); Thomas Andrew Tipton, Burlington, CT (US)

(21) Appl. No.: 14/033,860

(22) Filed: Sep. 23, 2013

(51) Int. Cl. G06Q 40/08

(52) U.S. Cl. CPC G06Q 40/08
USPC 705/4

(57) ABSTRACT

According to some embodiments, systems, methods, apparatus, computer program code and means may facilitate a group benefit insurance plan. In some embodiments, a group benefit insurance plan platform may be coupled to a computer storage unit for receiving, storing, and providing data associated with the group benefit insurance plan, including a base insurance policy characteristic. The platform may automatically determine a number of group members who have purchased insurance policies under the group benefit insurance plan. Based on the determined number, the platform may automatically apply a benefit to the base insurance policy characteristic.

### FIELD

The present invention relates to computer systems and more particularly to computer systems that provide a group benefit insurance plan platform.

### BACKGROUND

An entity may arrange to offer various types of insurance plans to group members. For example, an employer might work with an insurance company to offer short term disability policies to employees. Note that the overall risk, to the insurance company, associated with these types of group benefit insurance plans may be reduced when a substantial number of employees participate by purchasing insurance policies. However, the employer and employees may not be motivated to increase participation by members of the group. Moreover, it may be difficult and costly for the insurance company to encourage participation, especially when there are a substantial number of employees located in disperse regions.

It would therefore be desirable to provide systems and methods to promote group benefit insurance plans in an automated, efficient, and accurate manner.

### SUMMARY

According to some embodiments, systems, methods, apparatus, computer program code and means may promote a voluntary group benefit insurance plan. In some embodiments, a group benefit insurance plan platform may be coupled to a computer storage unit for receiving, storing, and providing data associated with the group benefit insurance plan, including a base insurance policy characteristic. According to some embodiments, group members may voluntarily purchase insurance policies under the group benefits plan. A target level of participation in the group benefits insurance plan by members of the group may be determined. The platform may automatically determine a number of group members who have purchased insurance policies under the group benefit insurance plan. Based on target level of participation and the determined number, the platform may automatically apply a benefit to the base insurance policy characteristic. An indication of the applied benefit may then be transmitted to at least some members of the group.

A technical effect of some embodiments of the invention is an improved and computerized method to promote a group benefit insurance plan. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 is a graph illustrating how premium costs might change based on group member participation in accordance with some embodiment.

FIG. 4 is another graph illustrating how premium costs might change based on group member participation in accordance with some embodiment.

FIG. 5 is block diagram of a group benefit insurance plan tool or platform according to some embodiments of the present invention.

FIG. 6 is a tabular portion of a group benefit insurance plan database according to some embodiments.

FIG. 7 is a short term disability insurance policy process flow in accordance with some embodiments.

FIG. 8 illustrates a group benefit insurance plan participation dashboard display in accordance with some embodiments.

FIG. 9 illustrates a tablet computer display in accordance with some embodiments described herein.

FIG. 10 illustrates an enrollment portal display according to some embodiments described herein.

FIG. 11 is a block diagram that illustrates aspects of a predictive model computer system provided in accordance with some embodiments of the invention.

### DETAILED DESCRIPTION

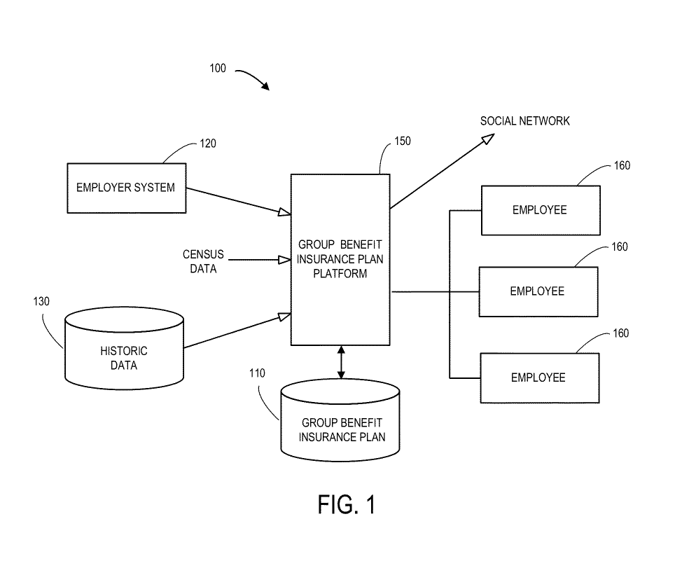

An entity may arrange to offer various types of insurance plans to group members. For example, a trade association or other type of affinity group might work with an insurance company to offer life insurance policies to members of the association. Note that the overall risk, to the insurance company, associated with these types of group benefit insurance plans may be reduced when a substantial number of members participate by purchasing insurance policies. However, the entity and group members may not be motivated to increase participation in the plan. Moreover, it may be difficult and costly for the insurance company to encourage participation, especially when there are a substantial number of members and/or members are located in disperse regions. It would therefore be desirable to provide systems and methods to promote group benefit insurance plans. FIG. 1 is block diagram of a system 100 according to some embodiments of the present invention. In particular, the system 100 includes a group benefit insurance plan platform 150 that maintains information about one or more group benefit insurance plans (e.g., by exchanging information with a group benefit insurance plan database 110). According to some embodiments, an employer system 120, such as a human resources system may provide information to the group benefit insurance plan platform 150 (e.g., including the gender and age of employees). In other embodiments, the group benefit insurance plan platform 150 may receive census data from other sources and/or access historic data 130 (e.g., about prior insurance policies and claims to help accurately determine an appropriate premium for a new insurance plan). In some embodiments, the group benefit insurance plan platform may transmit information about a group benefit insurance plan to employees (e.g., via email, postal mail, social networking sites, etc.).

The group benefit insurance plan platform 150 might be, for example, associated with a Personal Computers (PC), laptop computer, an enterprise server, a server farm, and/or a database or similar storage devices. The group benefit insurance plan platform 150 may, according to some embodiments, be associated with an insurance provider. According to some embodiments, the group benefit insurance plan platform 150 is associated with an insurance provider. In other cases, the group benefit insurance plan platform 150 might be associated with a vendor, such as a technology company that provides voluntary group benefit plan services for a number of different insurance providers and/or employers.

According to some embodiments, an “automated” group benefit insurance plan platform 150 may help promote a group benefit insurance plan. For example, the group benefit insurance plan platform 150 may automatically output a revised premium when a pre-determined number of employees participate in the plan. Information about discounted premiums that have been achieved and/or discounts that may be achieved in the future (e.g., if three more members purchase policies under the plan) may be automatically transmitted to members. As used herein, the terms “automated” and “automatically” may refer to, for example, actions that can be performed with little (or no) intervention by a human.

As used herein, devices, including those associated with the group benefit insurance plan platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The group benefit insurance plan platform 150 may store information into and/or retrieve information from the group benefit insurance plan database 110. The group benefit insurance plan database 110 might be associated with, for example, a client, an employer, or insurance policy and might store data associated with past and current insurance premiums and claims. The group benefit insurance plan database 110 may be locally stored or reside remote from the group benefit insurance plan platform 150. As will be described further below, the group benefit insurance plan database 110 may be used by the group benefit insurance plan platform 150 to generate predictive models. According to some embodiments, the group benefit insurance plan platform 150 communicates information about a group benefit insurance plan, such as by transmitting an electronic file to employees 160, a client device, an insurance agent or analyst platform, an email server, the employer system 120, a workflow management system, etc.

Although a single group benefit insurance plan platform 150 is shown in FIG. 1, any number of such devices may be included. Moreover, various devices described herein might be combined according to embodiments of the present invention. For example, in some embodiments, the group benefit insurance plan platform 150 and group benefit insurance plan database 110 might be co-located and/or may comprise a single apparatus.

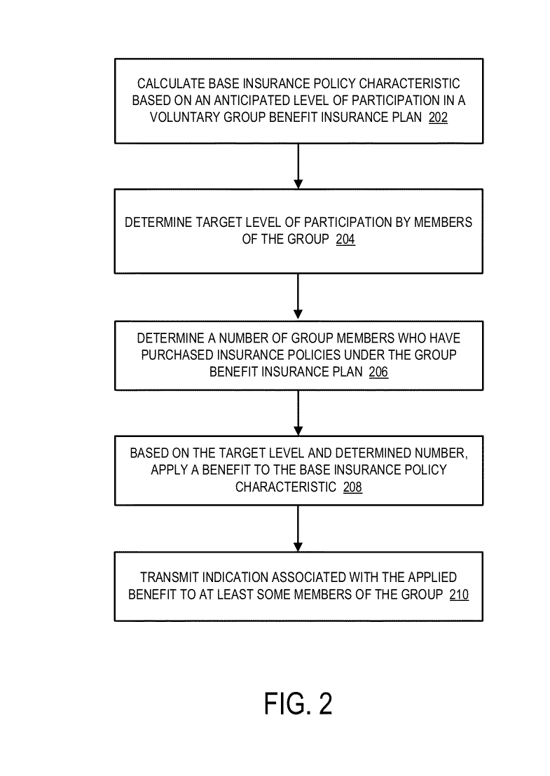

FIG. 2 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, a base insurance policy characteristic may be calculated based on an anticipated level of participation in a voluntary group benefit insurance plan. As used herein, a “voluntary” group benefit insurance plan might refer to, for example, coverage where members of a group have a choice to purchase products for themselves and their dependents through an employer or association sponsored program (and members will pay some or all of the insurance premium to obtain coverage). Note that different insurance policy characteristics might be calculated for different members. For example, one premium might be calculated for employees within a first age band (e.g., 18 to 40 years old) while another premium is calculated for employees within a second age band (e.g., over 40 years old).

In some cases, the group benefit insurance plan may be associated with an employer and group members may comprise employees of the employer. The insurance policy characteristic might refer to, for example, the premium or cost of the insurance policy. By way of example, an insurance company might anticipate that 25% of all employees will purchase long term disability insurance policies. Based on that prediction, an appropriate risk and premium may be calculated for the long term disability insurance policies. Note that embodiments may be associated with any type of group benefit, including life insurance, supplemental life insurance, long term disability insurance, short term disability insurance, critical illness insurance, accidental death insurance, dental insurance, and/or vision care insurance.

At 204, a target level of participation by members of the group may be determined. For example, an insurer may review census data from an employer and determine that between 20% and 30% of employees are likely to purchase long term disability insurance. As a result, a target of 30% might be selected (in which case members may be rewarded if more than 30% participate in the plan). In some cases, target participation levels may be made for all members of a group. In other cases, different target participation levels may be made for different subsets of the group (e.g., different age brackets might be associated with different target levels).

At 206, a number of group members who have purchased insurance policies under the group benefit insurance plan may be determined. For example, a group benefit insurance plan platform may maintain a running total of policies sold via a web site, on location sales, etc. Note that the determined number might be an actual number of employees (e.g., 37 employees out of a total of 148 employees), a percentage value (e.g., 29% of employees), or classification (e.g., between 40% and 50% of employees).

At 208, a benefit to the base insurance policy characteristic may be applied based on the target level of participation and the determined number. For example, when the base insurance policy characteristic is an insurance premium, the benefit applied to the base insurance policy characteristic might comprise a reduction to the premium (e.g., a reduction of 5% or $10.00) when a target level of participation has been exceeded. According to some embodiments, the group benefit insurance plan is associated with one type of insurance and, based on the determined number, a benefit may be applied to another insurance policy of a different type. For example, when 50% of all members of a trade union purchase long term disability insurance, vision care insurance may be provided for a lower premium.

Although reduced premiums are provided herein as an example, note that any other type of benefit may be applied instead. For example, the benefit applied to the base insurance policy characteristic might be associated with an increased amount of insurance coverage, a reduced deductible, and/or an improved term or condition of the insurance policy. Other types of benefit may be associated with, for example, additional offerings such as a weight management program, end-of-life planning, and/or an upgraded travel assistance service.

According to some embodiments, information about the applied benefit is automatically transmitted to members at 210. For example, an email text or image message might be transmitted to members who have already purchased insurance policies (e.g., to announce that their premiums will be lower). As another example, information might be transmitted to an email server, a workflow application, a calendar application, or a social networking site for members how have not yet purchases insurance policies (e.g., to let them know that a discounted premium will be achieved if five more members purchase insurance policies). As another example, the group benefit insurance plan platform might transmit an email to all employees announcing that the cost of dental insurance has been reduced by 5% and that it will be reduced by an additional 5% if ten more employees purchase insurance policies. In this ways, employees may be encouraged to participate (and to help get other employees to participate in the group benefit insurance plan).

Note that as employers are increasingly shifting the costs of group benefit plans to employees, there may be a growing need for insurance companies to competitively price the benefits. Moreover, the importance of educating employees regarding what the insurance covers, and why it is an important part of a financial plan, may be increased. Some embodiments provided herein may encourage individuals to communicate and promote the insurance benefits to fellow employees and/or associates. The group members may act as advocates and help communicate what disability and life insurance policies are and why they are important for most individuals to purchase. As a result of increased participation, employees may receive the benefit of lower premiums (due to the decrease in risk associated with increased participation).

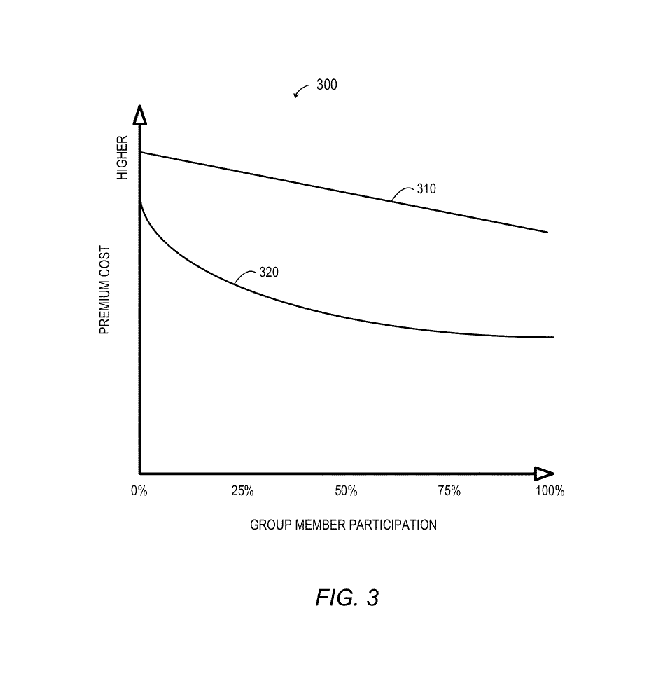

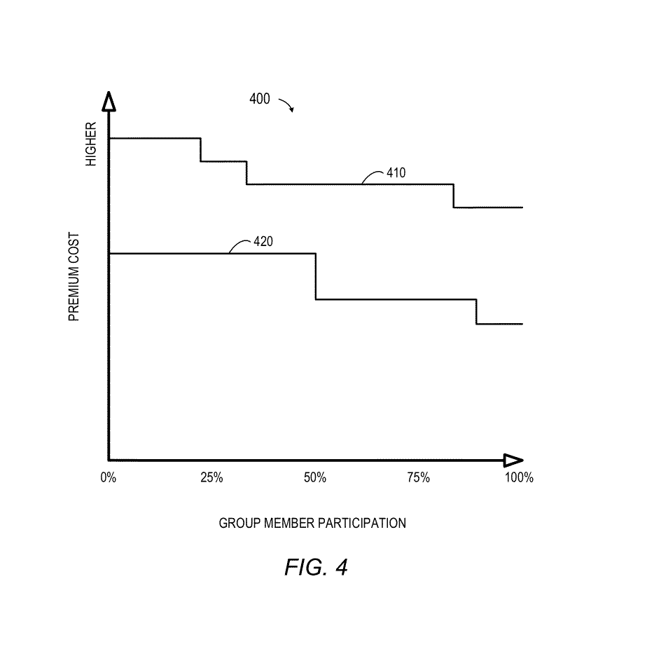

FIG. 3 is a graph 300 illustrating how premium costs might change based on group member participation in accordance with some embodiment. In some cases, the premium cost may linearly decrease 310 as participation by group members increase. Note, however, that other pricing algorithms 320 may instead be used as appropriate. FIG. 4 is another graph 400 illustrating how premium costs might change based on group member participation in accordance with some embodiment. In this case, a step function 410 may create premium “tiers” that change when a threshold level of participation is reached (e.g., the premium may remain constant until 30% participation is achieved, at which point the premium jumps down 10%). Note that, depending on the type of insurance, different pricing functions might be applied to different group members. For example, in the illustration of FIG. 4 the first line 410 might be applied for older employees while the second line 420 is applied for younger employees (to reflect their lower risk).

Note that various pricing and/or participation levels might be determined via a formula, algorithm, and/or one or more insurance based rules. For example, an insurance premium P might be calculated as follows:

$$P = {P}_{base} - ( \frac{{N}_{participating}}{{N}_{total}} - T ) \times W$$

Where P_{base} is a default base premium value, N_{participating} is how many employees are currently participating, Nₜₒₜₐₗ is an overall number of employees, T is a target level of participation (from 0 to 1, with 1 representing 100% participation), W is a weighing value reflecting how much of a reduced risk will result from the increased level of participation. The values in such equations might be based on, for example, prior enrollment periods with the same employer, enrollment periods of employers having similar employee census profiles, etc.

According to some embodiments, the applied benefit is dynamically calculated for each group member utilizing a dynamic pricing model. The pricing might, for example, start at a base level that is determined with underwriting of the entire group census file. The dynamic pricing may allow for ongoing price decreases as employees purchase coverage and the overall risk pool lets the insurance company decrease the pricing (due to the increase in participation and the spread of risk to individuals who have a lower risk profile as compared to the overall baseline group pricing). An online enrollment service may use a dynamic pricing algorithm that provides real-time pricing updates depending on the current level of participation and/or coverage amounts. The system may function as a dynamic reverse auction (note, however, that the price reductions may be determined by the insurance company's underwriting pricing model). The final rates may be fixed, for example, when an annual enrollment period closes. In this case, employees who enter into enrollment outside of enrollment period might utilize the same rates that were set by the group during the enrollment period. In this way, the system may include tools that allow employees to promote their participation and to encourage others in the group to participate so that the entire group rate will be lowered. Moreover, the system may use dynamic pricing that is dynamic to each employee or a tiered model that requires certain participation and coverage amounts to be reached before a next price level is attained.

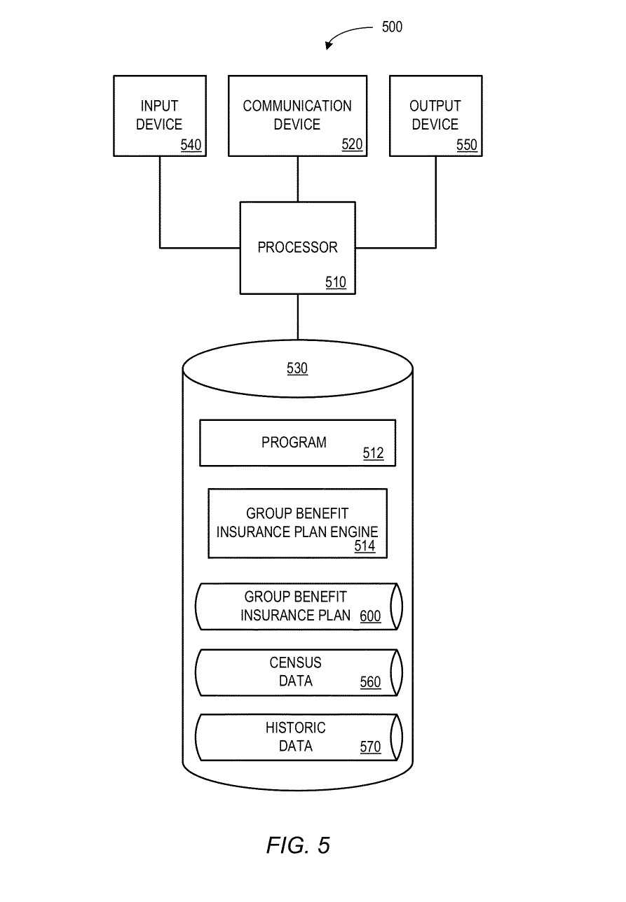

The embodiments described herein may be implemented using any number of different hardware configurations. For example, FIG. 5 illustrates a group benefit insurance plan platform 500 that may be, for example, associated with the system 100 of FIG. 1. The group benefit insurance plan platform 500 comprises a processor 510, such as one or more commercially available Central Processing Units (CPUs) in the form of one-chip microprocessors, coupled to a communication device 520 configured to communicate via a communication network (not shown in FIG. 5). The communication device 520 may be used to communicate, for example, with one or more employer and/or employee devices. The group benefit insurance plan platform 500 further includes an input device 540 (e.g., a mouse and/or keyboard to enter information about an insurance premium function) and an output device 550 (e.g., to output reports and emails to employees).

The processor 510 also communicates with a storage device 530. The storage device 530 may comprise any appropriate information storage device, including combinations of magnetic storage devices (e.g., a hard disk drive), optical storage devices, mobile telephones, and/or semiconductor memory devices. The storage device 530 stores a program 512 and/or a triage engine application 514 for controlling the processor 510. The processor 510 performs instructions of the programs 512, 514, and thereby operates in accordance with any of the embodiments described herein. For example, the processor 510 may receive, store, and provide data associated with a group benefit insurance plan, including a base insurance policy characteristic. The processor 510 may automatically determine a number of group members who have purchased insurance policies under the group benefit insurance plan. Based on the determined number, the processor 510 may automatically apply a benefit to the base insurance policy characteristic. Note that embodiments may be associated with any type of insurance product, including insurance policies, insurance riders, and/or adjustments to existing insurance products.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the group benefit insurance plan platform 500 from another device; or (ii) a software application or module within the group benefit insurance plan platform 500 from another software application, module, or any other source.

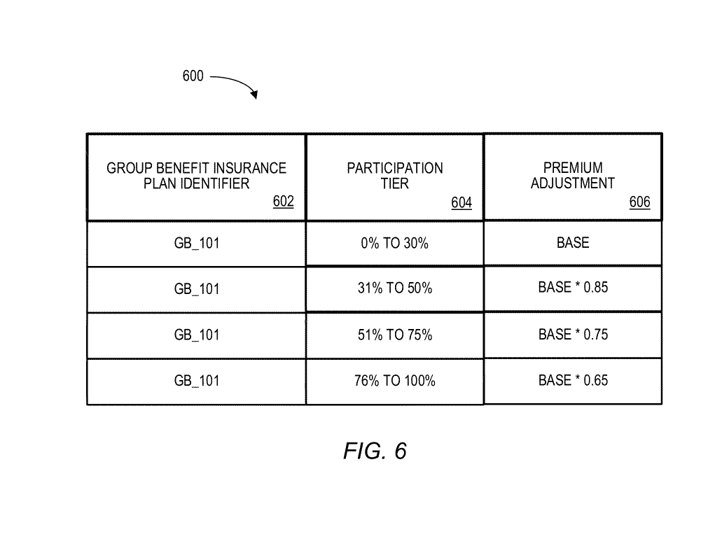

In some embodiments (such as shown in FIG. 5), the storage device 530 further stores a group benefit insurance plan database 600, census 560 (e.g., indicating employee age), and historic data 570 (e.g., to price future group benefit insurance plans appropriately). An example of a database that may be used in connection with the group benefit insurance plan platform 500 will now be described in detail with respect to FIG. 6. Note that the database described herein is only one example, and additional and/or different information may be stored therein. Moreover, various databases might be split or combined in accordance with any of the embodiments described herein. For example, the census data 560 and/or historic data 570 might be combined and/or linked to each other within the group benefit insurance plan engine 514.

Referring to FIG. 6, a table is shown that represents the group benefit insurance plan database 600 that may be stored at the group benefit insurance plan platform 500 according to some embodiments. The table may include, for example, entries identifying pricing information for a particular long term disability insurance policy or a number of different policies. The table may also define fields 602, 604, 606 for each of the entries. The fields 602, 604, 606 may, according to some embodiments, specify: a group benefit insurance plan identifier 602, a participation tier 604, and a premium adjustment 606. The group benefit insurance plan database 600 may be created and updated, for example, based on a predictive model.

The group benefit insurance plan identifier 602 may be, for example, a unique alphanumeric code identifying a particular plan that will be offered to employees. The participation tier 604 is defined by the percentage of employees who have purchased insurance policies under the plan and the premium adjustment 606 indicates how that level of participation will benefit the employees. For example, in the illustration of FIG. 6, the insurance premium is reduced to 75% of its original or “base” value when 60% of employees purchase insurance policies (as defined by the third participation tier 604 of “51% to 75%).

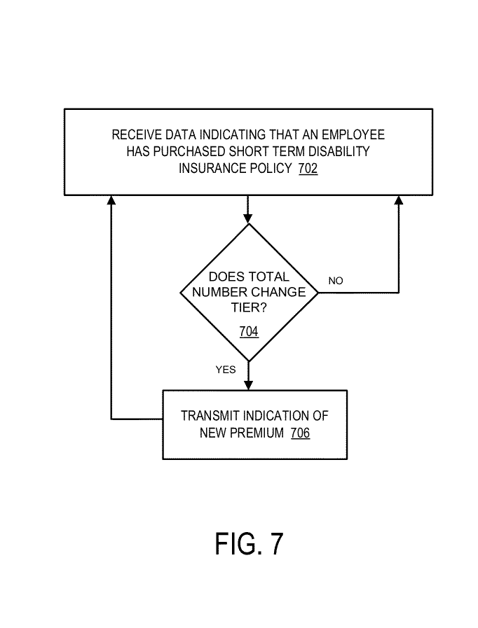

FIG. 7 is a short term disability insurance policy process flow in accordance with some embodiments. Initially, the system receives data indicating that an employee has purchased a short term disability insurance policy at 702. The system then determines if the total number of employees results in a participation tier change at 704. For example, when the threshold to enter the next pricing tier is 35%, the system determines whether or not the newly purchased policy results in that threshold being crossed. If not, the process ends until another policy is sold at 702. If the total number of employees who have purchased insurance policies does change the participation tier at 704, an indication of the new premium is automatically transmitted at 706 (e.g., by posting the indication to social networking site).

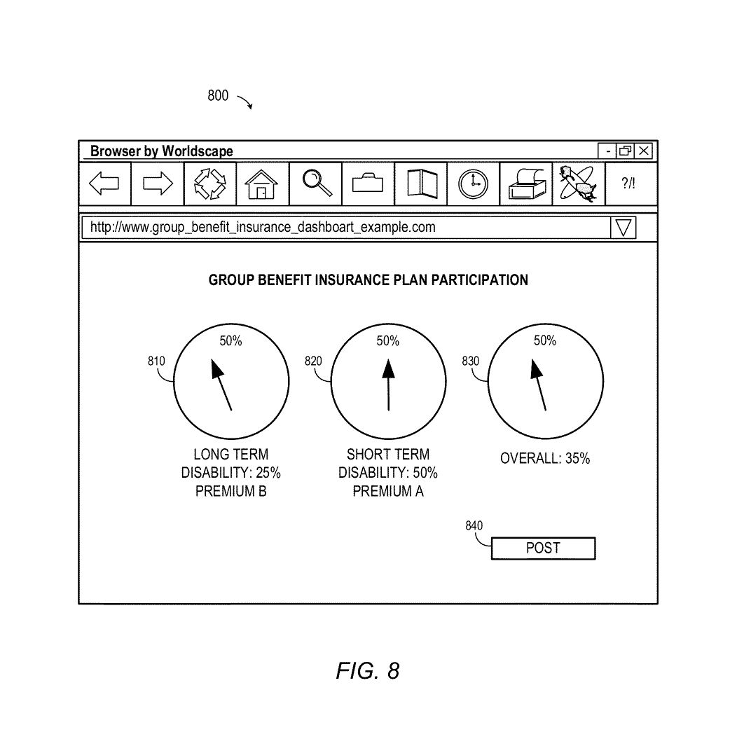

According to some embodiments, information about a current level of participation in the group benefit insurance plan may be graphically displayed to employees and/or plan administrators. For example, FIG. 8 illustrates a group benefit insurance plan participation dashboard display 800 in accordance with some embodiments. The display 800 might include, for example, participation information on an insurance product-by-product basis (e.g., a long term disability participation level gauge and current premium 810 and a short term disability participation level gauge and current premium 820). According to some embodiments, the display 800 may further include a tic mark or other graphical feature indicating when the next premium tier would be reached. Note that that display may also include an overall participation level gauge and current premium 830 (e.g., based on different types of insurance policies).

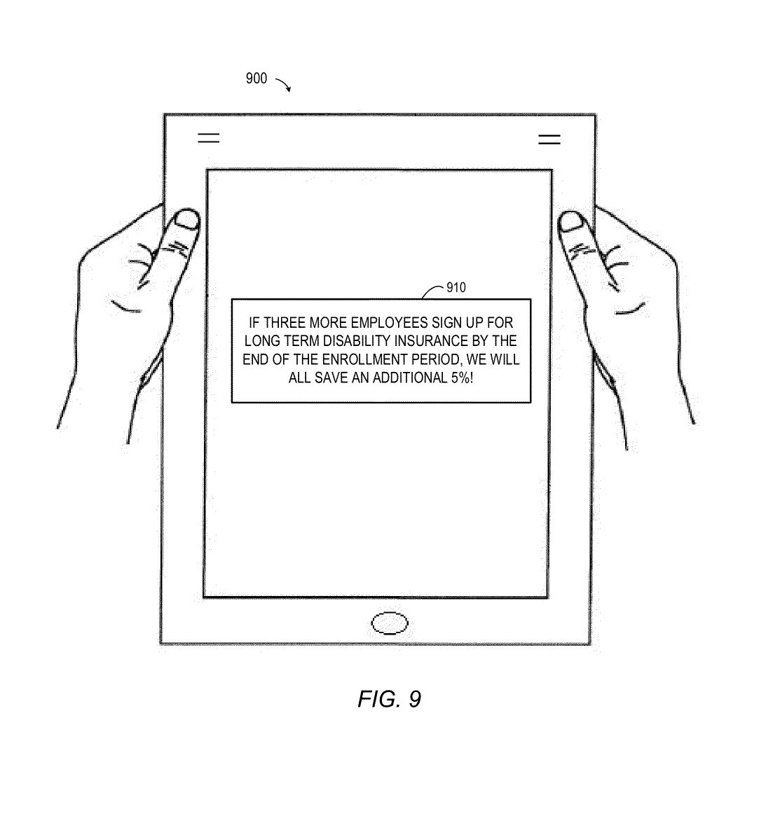

Information other than participation levels may also be displayed (e.g., to employees or plan administrators). FIG. 9 illustrates a tablet computer display 900 in accordance with some embodiments described herein. The display 900 includes a message 910 stating that if three more employees sign up for long term disability insurance by the end of the enrollment period, premiums will be reduced by an additional 5% for all employees.

In general, and for the purposes of introducing concepts of embodiments of the present invention, a computer system may incorporate a “predictive model” that may, for example, establish participation pricing functions and/or tiers for a group benefit insurance plan. As used herein, the phrase “predictive model” might refer to, for example, any of a class of algorithms that are used to understand relative factors contributing to an outcome, estimate unknown outcomes, discover trends, and/or make other estimations based on a data set of factors collected across prior trials. Note that a predictive model might refer to, but is not limited to, methods such as ordinary least squares regression, logistic regression, decision trees, neural networks, generalized linear models, and/or Bayesian models. The predictive model is trained with historical premium and claim transaction data, and is applied to a new group benefit insurance plan to help determine a pricing/participation function. Both the historical data and data representing the new policy might include, according to some embodiments, indeterminate data or information extracted therefrom. For example, such data/information may come from narrative and/or medical text notes associated with a claim file.

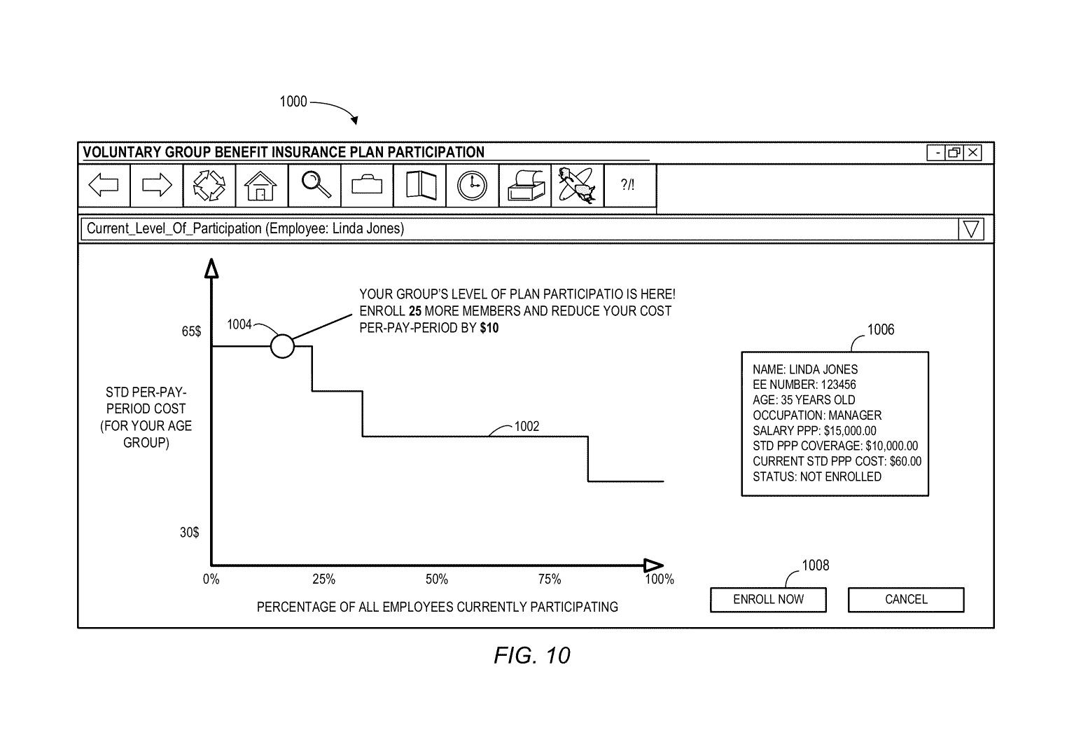

FIG. 10 illustrates an enrollment portal display 1000 according to some embodiments described herein. The enrollment portal display 1000 might be associated with, for example, an employer, an insurance enterprise, and/or a vendor providing insurance and/or technology related services. The display 1000 includes a graphical display 1002 showing how a short term disability per-pay-period cost for a particular age group will decrease as the level of participation (i.e., the percentage of all employees who are currently participating by having purchased insurance policies under the plan) increases. The display 1000 further includes a current level 1004 showing the employee how many employees are participating (and how far the plan is from achieving the next premium discount). The display 1000 may further include pre-populated employee information 1006 (e.g., automatically retrieved from a human resources database when the employee logged onto the insurance plan portal). The pre-populated employee information 1006 might include, for example, an employee name, an employee identifier, an employee age or date of birth, an employee occupation or job title, an employee salary and/or disability coverage amounts, and/or a current cost of insurance (based on the current level of participation). The display 1000 may further include an icon 1008 that, when activated by the employee, begins an insurance policy enrollment process.

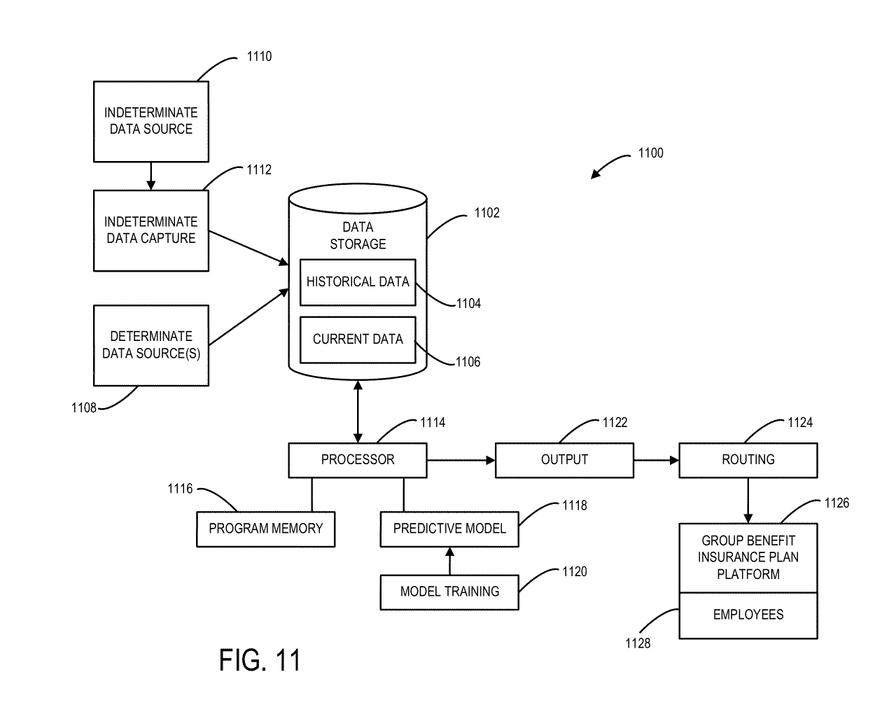

Features of some embodiments associated with a predictive model will now be described by first referring to FIG. 11. FIG. 11 is a block diagram that illustrates aspects of a computer system 1100 provided in accordance with some embodiments of the invention. For present purposes it will be assumed that the computer system 1100 is operated by an insurance company (not separately shown) for the purpose of appropriately pricing group benefit insurance plans and/or participation level targets.

The computer system 1100 includes a data storage module 1102. In terms of its hardware the data storage module 1102 may be conventional, and may be composed, for example, by one or more magnetic hard disk drives. A function performed by the data storage module 1102 in the computer system 1100 is to receive, store and provide access to both historical data (reference numeral 1104) and current data, such as employee census data and participation data (reference numeral 1106). As described in more detail below, the historical data 1104 is employed to train a predictive model to provide an output that indicates how a group benefit insurance plan might be priced. Moreover, as time goes by, and results become known from processing current data, at least some of the current data may be used to perform further training of the predictive model. Consequently, the predictive model may thereby adapt itself to changing patterns of group benefit insurance plans.

Either the historical data 1104 or the current data 1106 might include, according to some embodiments, determinate and indeterminate data. As used herein and in the appended claims, “determinate data” refers to verifiable facts such as the date of birth, age or name of a claimant or name of another individual or of a business or other entity; a type of injury, accident, sickness, or pregnancy status; a medical diagnosis; a date of loss, or date of report of claim, or policy date or other date; a time of day; a day of the week; a vehicle identification number, a geographic location; and a policy number.

As used herein and in the appended claims, “indeterminate data” refers to data or other information that is not in a predetermined format and/or location in a data record or data form. Examples of indeterminate data include narrative speech or text, information in descriptive notes fields and signal characteristics in audible voice data files. Indeterminate data extracted from medical notes might be associated with, for example, a prior injury or obesity related co-morbidity information.

The determinate data may come from one or more determinate data sources 1108 that are included in the computer system 1100 and are coupled to the data storage module 1102. The determinate data may include “hard” data like an employee's name, date of birth, social security number, policy number, address; a date of loss; a date the claim was reported, etc. One possible source of the determinate data may be the insurance company's policy database (not separately indicated). Another possible source of determinate data may be from a human resources database or data entry by an employer.

The indeterminate data may originate from one or more indeterminate data sources 1110, and may be extracted from raw files or the like by one or more indeterminate data capture modules 1112. Both the indeterminate data source(s) 1110 and the indeterminate data capture module(s) 1112 may be included in the computer system 1100 and coupled directly or indirectly to the data storage module 1102. Examples of the indeterminate data source(s) 1110 may include data storage facilities for document images, for text files (e.g., claim handlers' notes) and digitized recorded voice files (e.g., participants' statements to a telephone call center). Examples of the indeterminate data capture module(s) 1112 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1100 also may include a computer processor 1114. The computer processor 1114 may include one or more conventional microprocessors and may operate to execute programmed instructions to provide functionality as described herein. Among other functions, the computer processor 1114 may store and retrieve historical data 1104 and data 1106 in and from the data storage module 1102. Thus the computer processor 1114 may be coupled to the data storage module 1102.

The computer system 1100 may further include a program memory 1116 that is coupled to the computer processor 1114. The program memory 1116 may include one or more fixed storage devices, such as one or more hard disk drives, and one or more volatile storage devices, such as RAM (random access memory). The program memory 1116 may be at least partially integrated with the data storage module 1102. The program memory 1116 may store one or more application programs, an operating system, device drivers, etc., all of which may contain program instruction steps for execution by the computer processor 1114.

The computer system 1100 further includes a predictive model component 1118. In certain practical embodiments of the computer system 1100, the predictive model component 1118 may effectively be implemented via the computer processor 1114, one or more application programs stored in the program memory 1116, and data stored as a result of training operations based on the historical data 1104. In some embodiments, data arising from model training may be stored in the data storage module 1102, or in a separate data store (not separately shown). A function of the predictive model component 1118 may be to determine an appropriate pricing for group benefit insurance plans. The predictive model component 1118 may be directly or indirectly coupled to the data storage module 1102.

The predictive model component 1118 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1100 includes a model training component 1120. The model training component 1120 may be coupled to the computer processor 1114 (directly or indirectly) and may have the function of training the predictive model component 1118 based on the historical data 1104. (As will be understood from previous discussion, the model training component 1120 may further train the predictive model component 1118 as further relevant data becomes available.) The model training component 1120 may be embodied at least in part by the computer processor 1114 and one or more application programs stored in the program memory 1116. Thus the training of the predictive model component 1118 by the model training component 1120 may occur in accordance with program instructions stored in the program memory 1116 and executed by the computer processor 1114.

In addition, the computer system 1100 may include an output device 1122. The output device 1122 may be coupled to the computer processor 1114. A function of the output device 1122 may be to provide an output that is indicative of (as determined by the trained predictive model component 1118) pricing for group benefit insurance plans. The output may be generated by the computer processor 1114 in accordance with program instructions stored in the program memory 1116 and executed by the computer processor 1114. More specifically, the output may be generated by the computer processor 1114 in response to applying the data for the current data 1106 to the trained predictive model component 1118. The output may, for example, be a true/false flag or a number within a predetermined range of numbers. In some embodiments, the output device may be implemented by a suitable program or program module executed by the computer processor 1114 in response to operation of the predictive model component 1118.

Still further, the computer system 1100 may include a routing module 1124. The routing module 1124 may be implemented in some embodiments by a software module executed by the computer processor 1114. The routing module 1124 may have the function of directing workflow based on the output from the output device. Thus the routing module 1124 may be coupled, at least functionally, to the output device 1122. In some embodiments, for example, the routing module may provide pricing/participation information to a group benefit insurance plan platform 1126, which in turn might provide the data to a plan administrator and/or employees 1128 or other affinity group members (e.g., via a web site).

The predictive model 1118, in various implementation, may include one or more of neural networks, Bayesian networks (such as Hidden Markov models), expert systems, decision trees, collections of decision trees, support vector machines, or other systems known in the art for addressing problems with large numbers of variables. Preferably, the predictive model(s) are trained on prior data and outcomes known to the insurance company. The specific data and outcomes analyzed vary depending on the desired functionality of the particular predictive model 1118. The particular data parameters selected for analysis in the training process are determined by using regression analysis and/or other statistical techniques known in the art for identifying relevant variables in multivariable systems. The parameters can be selected from any of the structured data parameters stored in the present system, whether the parameters were input into the system originally in a structured format or whether they were extracted from previously unstructured text.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system associated with a group benefit insurance plan, the system comprising:
a computer storage unit for receiving, storing, and providing data associated with the group benefit insurance plan, including a base insurance policy characteristic, wherein members of a group may voluntarily purchase insurance policies under the group benefits insurance plan; and
a processor in communication with the storage unit, wherein the processor is configured for:
determining a target level of participation in the group benefits insurance plan by members of the group;
determining a number of group members who have purchased insurance policies under the group benefit insurance plan;
based on the target level of participation and the determined number, applying a benefit to the base insurance policy characteristic; and
automatically transmitting an indication associated with the applied benefit to at least some members of the group.

2. The system of claim 1, wherein the indication is transmitted to at least one of: (i) at least some members of the group who have purchased insurance policies under the group benefits plan, and (ii) at least some members of the group who have not purchased insurance policies under the group benefits plan.

3. The system of claim 1, wherein the group benefit insurance plan is associated with an employer and the group members comprise employees of the employer.

4. The system of claim 3, wherein the base insurance policy characteristic comprises an insurance premium and the benefit applied to the base insurance policy characteristic comprises a reduction to the premium.

5. The system of claim 1, wherein the benefit applied to the base insurance policy characteristic is associated with at least one of: (i) an increased coverage, (ii) a reduced deductible, and (iii) an improved term or condition.

6. The system of claim 1, wherein the group benefit insurance plan is associated with at least one of: (i) life insurance, (ii) supplemental life insurance, (iii) long term disability insurance, (iv) short term disability insurance, (v) critical illness insurance, (vi) accidental death insurance, (vii) dental insurance, and (viii) vision care insurance.

7. The system of claim 1, wherein the transmitted indication is associated with at least one of: (i) an email server, (ii) a workflow application, (iii) a calendar application, (iv) a text message, (v) an image, and (vi) a social networking web site.

8. The system of claim 1, wherein the processor is further configured for:
calculating a first base insurance policy characteristic for group members within a first age band and a second base insurance policy characteristic for group members within a second age band, wherein at least one of the first and second base insurance policy characteristics is based on an anticipated level of participation in the group benefit insurance plan.

9. The system of claim 1, wherein the group benefit insurance plan is associated with one type of insurance and the processor is further configured for:
based on the determined number, applying a benefit to another insurance policy of a different type.

10. The system of claim 1, wherein the processor is further configured for:
graphically display a current level of participation in the group benefit insurance plan.

11. The system of claim 1, wherein the applied benefit is dynamically calculated for each group member.

12. A computerized method associated with a group benefit insurance plan having a base insurance policy characteristic, wherein members of a group may voluntarily purchase insurance policies under the group benefits insurance plan, the method comprising:
automatically determining, by a computer processor of a group benefit insurance plan platform, a target level of participation in the group benefits insurance plan by members of the group;
automatically determining, by the computer processor of the group benefit insurance plan platform, a number of group members who have purchased insurance policies under the group benefit insurance plan;
based on target level of participation and the determined number, automatically applying, by the computer processor of the group benefit insurance plan platform, a benefit to the base insurance policy characteristic; and
automatically transmitting, by the computer processor of the group benefit insurance plan platform, an indication associated with the applied benefit to at least some members of the group.

13. The method of claim 12, wherein the group benefit insurance plan is associated with an employer and the group members comprise employees of the employer.

14. The method of claim 13, wherein the base insurance policy characteristic comprises an insurance premium and the benefit applied to the base insurance policy characteristic comprises a reduction to the premium.

15. The method of claim 12, wherein the benefit applied to the base insurance policy characteristic is associated with at least one of: (i) an increased coverage, (ii) a reduced deductible, and (iii) an improved term or condition.

16. The method of claim 12, wherein the group benefit insurance plan is associated with at least one of: (i) life insurance, (ii) supplemental life insurance, (iii) long term disability insurance, (iv) short term disability insurance, (v) critical illness insurance, (vi) accidental death insurance, (vii) dental insurance, and (viii) vision insurance.

17. The method of claim 12, wherein the transmitted indication is associated with at least one of: (i) an email server, (ii) a workflow application, (iii) a calendar application, (iv) a text message, (v) an image, and (vi) a social networking web site.

18. The method of claim 12, further comprising:
calculating the base insurance policy characteristic based on an anticipated level of participation in the group benefit insurance plan.

19. A system associated with a group benefit insurance plan, the system comprising:
a computer storage unit for receiving, storing, and providing data associated with the group benefit insurance plan, including a base insurance product characteristic; and
a processor in communication with the storage unit, wherein the processor is configured for:
determining a number of group members who have purchased insurance products under the group benefit insurance plan; and
based on the determined number, applying a benefit to the base insurance product characteristic.

20. The system of claim 19, wherein the insurance product is associated with at least one of: (i) an insurance policy, (ii) an insurance rider, and (iii) an adjustment to an existing insurance product.

21. The system of claim 18, wherein said determining is performed by at least one of: (i) an insurance enterprise, (ii) an employer, and (iii) an insurance company vendor.

22. A non-transitory, computer-readable medium storing instructions adapted to be executed by a computer processor to perform a method associated with a group benefit insurance plan having a base insurance policy characteristic, wherein members of a group may voluntarily purchase insurance policies under the group benefits insurance plan, the method comprising:
automatically determining, by a computer processor of a group benefit insurance plan platform, a target level of participation in the group benefits insurance plan by members of the group;
automatically determining, by the computer processor of the group benefit insurance plan platform, a number of group members who have purchased insurance policies under the group benefit insurance plan; and
based on target level of participation and the determined number, automatically applying, by the computer processor of the group benefit insurance plan platform, a benefit to the base insurance policy characteristic; and
automatically transmitting, by the computer processor of the group benefit insurance plan platform, an indication associated with the applied benefit to at least some members of the group.

23. The medium of claim 22, wherein the base insurance policy characteristic comprises an insurance premium and the benefit applied to the base insurance policy characteristic comprises a reduction to the premium.
